(19) United States
(12) Patent Application Publication
(10) Pub. No.: US 2018/0374077 A1
(43) Pub. Date: Dec. 27, 2018

(54) DATA TRANSMISSION AND PROCESSING ARRANGEMENT AND DATA TRANSMISSION AND PROCESSING METHOD FOR PAYMENT OF A PRODUCT OR SERVICE

(71) Applicant: Rubean AG, Munich (DE)

(72) Inventors: Hermann Geupel, Munich (DE); Henrik Pein, Pinneberg (DE)

(21) Appl. No.: 16/018,535

(22) Filed: Jun. 26, 2018

(30) Foreign Application Priority Data
Jun. 27, 2017 (DE) 102017114275.4
Jul. 6, 2017 (DE) 102017115074.9
Mar. 13, 2018 (DE) 102018105757.1

(51) Int. Cl. G06Q 20/32; H04M 1/725

(52) U.S. Cl. CPC G06Q 20/3278; H04M 1/72522; H04W 4/80; H04M 2250/04; G06Q 20/3221

(57) ABSTRACT

A data transmission and processing arrangement for customer payment of a product or service at a retailer point of sale, wherein the arrangement comprises: a retailer device equipped for near-field data communication, NFC, which comprises a working memory for storing payment data of a payment transaction and a first data exchange software component interacting with the working memory as well as the near-field data communication equipment which provides the payment data in a standardized data exchange format in the passive readout mode as well as a data interface for actively transmitting the payment data externally over the internet, a customer device equipped for near-field data communication, NFC, which comprises a virtualized bank card with banking details stored thereon, a second data exchange software component interacting with the near-field data communication equipment which is designed to actively read out the payment data on the retailer device provided by the first data exchange software component, a processing device which interacts with the virtualized bank card and the second data exchange software component for generating a payment order dataset from the banking details and the payment data, and a working memory for storing the payment order dataset as well as a data interface for the wireless external transmitting of the payment order dataset, and a payment service provider server of a payment service provider comprising receiving means for receiving the payment data from the retailer device and the payment order dataset from the customer device, processing means for comparative processing of both datasets, and transmitting means connected to the processing means for transmitting a confirmation message authorizing the payment to the retailer device over the internet.

The invention relates to a data transmission and processing arrangement for customer payment of a product or service at a retailer point of sale as well as a corresponding data transmission and processing method.

The on-site “electronic” payment of goods or services; i.e. at a retailer's point of sale, using a bank or credit card has long been standard in everyday payment transactions. In recent years, there has also thereby been intensified use of retailer terminals, so-called point-of-sales (PoS) terminals, which are equipped for near-field data communication with a likewise endowed bank card.

In recent years, substantial developments have been pursued in which a bank card is implemented in virtualized form in an intelligent customer device, in particular a smartphone, so that the smartphone's owner can use his bank account solely by using the smartphone—thus without using a physical bank card—and thereby also realize payment transactions.

In addition, the method of near-field data communication according to the NFC standard has steadily become more widely available, even beyond just payment transactions of the aforementioned type alone. The smartphones of the Apple manufacturer have recently offered mobile app vendors a function via which the smartphone NFC Data Exchange Format (NDEF) can read out data from other NFC devices. Other well-known smartphone manufacturers already support this NFC data format such that it can be used to create a new payment process which covers all common smartphones.

The invention is based on the task of specifying a constructive solution for the on-site payment of goods or services at a retailer's location using a suitable customer device, said solution being simple and yet at the same time secure and can thus anticipate having high user acceptance.

With respect to the device, this task is solved by an arrangement having the features of claim 1, 2 or 3 and with respect to its method, by a method having the features of claim 10, 11 or 12. Advantageous further developments of the inventive concept constitute the subject matter of the dependent claims.

The present invention indicates a solution which enables mobile app vendors to develop mobile payment solutions for smartphones which are accepted at established point-of-sales (POS) terminals.

The proposed arrangement comprises an NFC-capable retailer device, an NFC-capable customer device and a retailer payment service provider server, wherein the NFC retailer device comprises a first data exchange software component (hereinafter also “software component 1”) which makes the payment data available for readout by the NFC customer device in passive NFC mode and in particular in the NFC Data Exchange Format (NDEF) and the NFC customer device comprises a second data exchange software component (hereinafter also “software component 2”) which imports the payment data in active mode and interprets as NDEF-formatted payment data.

The NFC customer device in particular comprises a virtualized payment card which is virtualized on the NFC customer device in the form of a Host Card Emulation (HCE) and protected by the white-box cryptography principle.

Furthermore, the retailer device comprises switching means for switching from an active NFC operating mode, in which Request-to-Answer-To-Select (RATS) commands are sent, into the passive readout mode in response to no Answer-To-Select (ATS) response from the customer device after a predefined interval of time. The payment service provider server in particular comprises transmitting means for transmitting a payment confirmation to the retailer device as well as for transmitting an additional confirmation message to the customer device over a wireless network.

Method aspects of the invention essentially correspond to the arrangement aspects and are inasmuch not reiterated here.

Reference is, however, made to one implementation in which prior to providing the payment data in the passive read-out mode, the retailer device sends out RATS commands in an active NFC operating mode and switches into the passive read-out mode upon no response after a predefined interval of time. One configuration provides for the back and forth switching from active NFC operating mode into passive read-out mode to be cyclically repeated a number of times until the retailer device identifies the NFC mode in which the customer device is to be addressed.

In a further configuration, the payment data is actively transmitted from the retailer device to the payment service provider server in response to the retailer device having exchanged the payment data with the customer device in one of the two NFC modes.

The payment data particularly comprises an identification of the retailer device, a transaction identification and a payment amount, and is in particular digitally signed by a signature component in the retailer device.

Provided to further increase the security of the data transmission is for the customer to be legitimized at the customer device via acquisition and analysis of a biometric feature or input and analysis of a PIN prior to and as a condition for the step of the customer device actively reading out the payment data. Further provided in terms of this aspect is for the payment order dataset to be digitally signed in the customer device, in particular by the virtualized bank card, before being transmitted to the payment service provider server.

In a further configuration, in addition to or in place of the customary payment service provider server linked to a POS terminal, also called network provider in Germany, another online payment service provider is integrated which communicates with a mobile online payment service provider app on the customer device. To verify the authenticity of the payment order, the bank of the customer paying at the point-of-sale terminal then does not necessarily need an aforementioned bank card signature but can execute the payment as a direct debit and leave the customer authentication to the online payment service provider which normally authenticates the customer via the online payment service provider app and a password or PIN input and/or biometric feature.

Since according to today's EMC requirement, the POS terminal may only be switched into active NFC operating mode and not passive readout mode in a traditional EMC card transaction, software component 1 must be installed on the POS terminal outside of the so-called EMC core and can be directly connected to any given payment service provider which does not necessarily have to be a network provider but rather can also be solely an online payment service provider.

If the customer device is to independently process the payment data via a payment service provider after same having been read out from the POS terminal by means of NFC pursuant to the inventive principle, the customer device needs to have an online connection. That is not always the case at point-of-sale terminals.

A further configuration addresses the payment data, after having been received from the customer device via NFC and the customer authorizing payment there, not being received via the customer device but rather via the NFC retailer device for the payment service provider. To generate or forward the payment order dataset, the NFC retailer device reads in customer data beforehand via Bluetooth or WLAN, such as an IBAN account or a card number or, respectively, the previously created payment order dataset. In the latter case, the retailer device functions as a gateway between the customer device and the payment service provider server.

Compared to just a Bluetooth connection between the two devices, the combination of an initial NFC connection with a subsequent Bluetooth connection between the POS terminal and customer device has the advantage of the customer intuitively expressing the intention to pay with an NFC connection, by the customer having to hold his customer device close to the NFC point of the POS terminal while a Bluetooth connection can be established at a distance of for example 1m without any corresponding action on the part of the customer and the customer then needs to manually select the appropriate retailer device.

The two Bluetooth/WLAN communication partners; i.e. the retailer device and the customer device, can be automatically connected, for example by the customer device also receiving from the retailer device, in addition to the payment data, the Bluetooth identification code or the EAP (Extensible Authentication Protocol) WLAN code of the retailer device respectively and then precisely establishing a Bluetooth/WLAN connection with same.

The Bluetooth/WLAN passwords to access the retailer device can be generated dynamically by same just for the respective session and communicated to the customer device via NFC. This prevents fraudulent replay attacks.

The NFC retailer device can be a stationary or mobile POS terminal. Recently, commercially available smartphones have also been able to be used as mobile POS terminals in conjunction with the applicable mobile apps.

Advantages and functionalities of the invention in other respects are yielded by the following explanation of example embodiments based on the accompanying figures, which show:

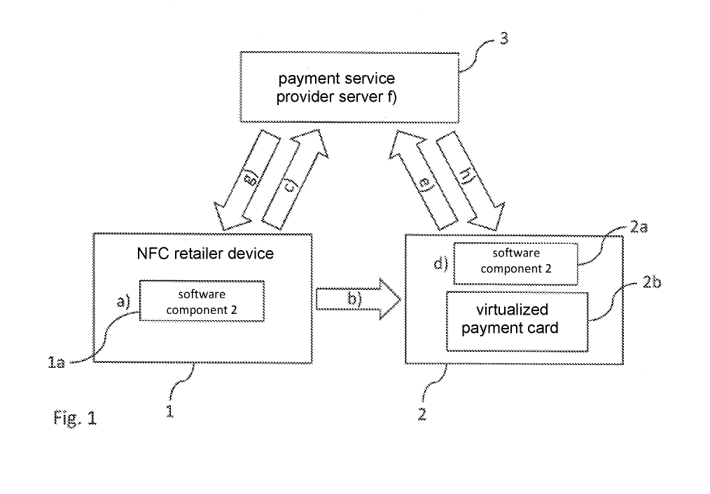

FIG. 1 a schematic representation of a system and process of rendering payment at a point-of-sale terminal according to the invention,

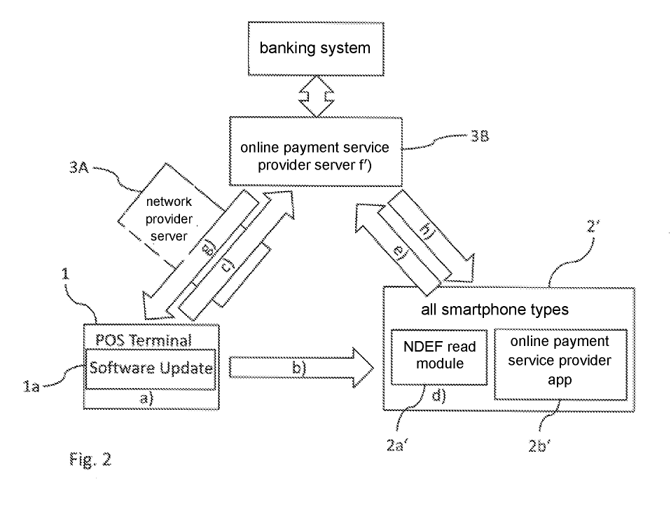

FIG. 2 a schematic representation of an inventive system and process of rendering payment at a point-of-sale terminal based on a further example embodiment,

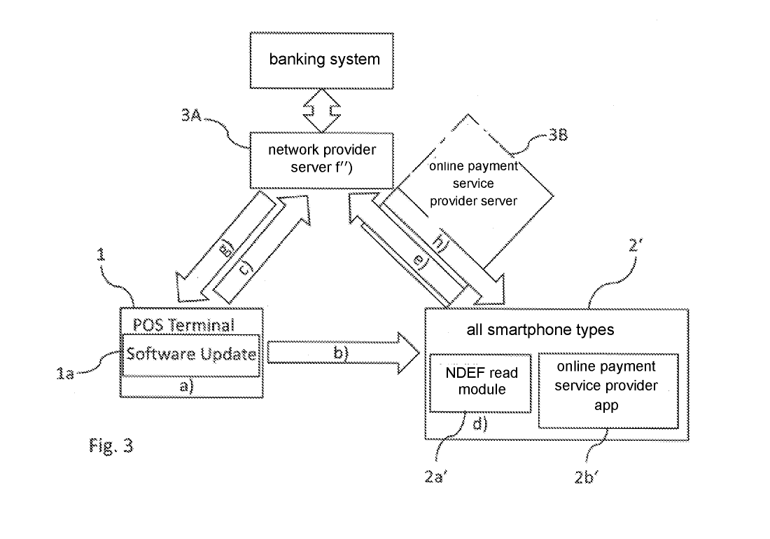

FIG. 3 a schematic representation of an inventive system and process of rendering payment at a point-of-sale terminal based on a further example embodiment, and

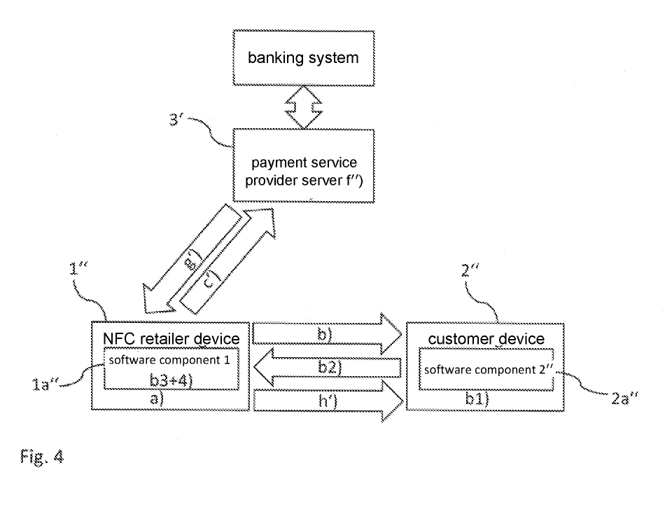

FIG. 4 a schematic representation of the inventive system and process using an additional Bluetooth or WLAN connection.

In accordance with FIG. 1, which is to be understood as a combined block diagram and flow chart, the arrangement comprises an NFC-capable retailer device 1, an NFC-capable customer device 2 and a payment service provider server 3. All that is individually designated by numeral 1a in the following example explanation is one software component 1 in the NFC retailer device 1; by numeral 2a, one software component 2 in the NFC customer device 2, and by numeral 2b, one virtualized payment card. Although the further functional units of the arrangement's components specified in the claims are omitted for the sake of simplification, it is also expressly noted that configurations of the invention are possible in which not all of these functional units are necessarily provided.

At the beginning of the payment procedure, the retailer device 1 displays a payment amount on a corresponding display and thereby holds a payment dataset ready internally. When the retailer device detects the approaching of the NFC customer device 2 (particularly by a change in the detected electromagnetic field strength), it sends the usual RATS command in active NFC mode to establish a connection, which is in particular defined with a passive NFC communication partner.
a) If the NFC retailer device 1 does not receive a response from the NFC customer device 2 within a specific period of time, it changes to the passive NFC mode, controlled by software component 1, and then provides the payment data to the NFC customer device 2 in the NDEF format.
b) The NFC customer device 2 held to the NFC retailer device 1 retrieves, controlled by software component 2, the payment data from the NFC retailer device 1 in the active NFC mode.
c) After the NFC retailer device 1 has detected that the NFC customer device 2 has read out the payment data, the NFC retailer device 1 simultaneously sends the payment data to the server 3 of the connected payment service provider and requests a response.
d) The NFC customer device 2 creates a payment order dataset in software component 2 on the basis of the payment data
e) and sends same to the server 3 of the payment service provider.
f) The server 3 of the payment service provider checks the data from the NFC customer device 2 for consistency with that received from the NFC retailer device 1 and verifies approval of the payment.
g) The server 3 of the payment service provider lastly sends a confirmation message to the NFC retailer device 1.

Additionally to the payment service provider connected to the retailer device, FIGS. 2 and 3 show in similar synoptic representations to FIG. 1 the integration of an online payment service provider such as, for example, paydirekt or Paypal, called network provider in Germany. Wherever the system components and steps coincide with or functionally correspond to those from FIG. 1, the same reference symbols are used in these cases as used there.

Taking the place of the server 3 of the online payment service provider in the arrangement according to FIG. 2 is a server 3A of a network provider and a server 3B of an payment service provider ultimately connecting to a (not separately designated) bank system. Differing from the internal functionality shown in FIG. 1, a standardized NDEF reader module 2A′ as can be used in virtually all common smartphone types is implemented in customer device 2′ and the device functions which are essential to the invention are based on an app 2b′ provided by the online payment service provider loaded in the smartphone.

According to FIG. 2, the online payment service provider server 3B verifies the payment approval vis-à-vis the bank system in step f) and the network provider server 3A functions as a communication channel to the retailer device 1.

Furthermore, reference is made to claim 10 with regard to the method steps according to FIG. 2.

In the arrangement and the method according to FIG. 3, the server 3A of the network provider is in direct connection with the bank system and the server 3B of the online payment service provider “stands” between the server 3A of the network provider and the customer device 2′.

According to FIG. 3, the network provider server 3A verifies the payment approval vis-à-vis the bank system in step f″) and the online payment service provider server 3A functions as a communication channel to the smartphone. Wherever the system components and steps coincide with or functionally correspond to those from FIG. 1, the same reference symbols are used in these cases as used there. Furthermore, reference is made to claim 11 with regard to the method steps according to FIG. 3.

FIG. 4 shows an arrangement and a method with which the customer device does not have to be online for the transaction to take place.
a) If the NFC retailer device 1″ does not receive a response from the NFC customer device 2″ within a specific period of time, it changes to the passive NFC mode, controlled by software component 1A″, and provides the payment data and its own Bluetooth or WLAN access coordinates in the NDEF format to the NFC customer device 2″.
b) The NFC customer device 2″ held to the NFC retailer device 1″ retrieves, controlled by software component 2A″, the payment data and the Bluetooth/WLAN access coordinates from the NFC retailer device 1″ in the active NFC mode and allows the customer to authorize the payment, e.g. by fingerprint.
b1) Software component 2A″ creates a payment order dataset from the received payment data and the payment-related customer identification data, for example the IBAN account number or a customer EMC card number stored in software component 2A″.
   Alternatively thereto, the payment order dataset can also be compiled in a later step b3) in software component 1″ of the retailer device from the existing payment data there and the customer identification data transmitted in step b2).
b2) With the Bluetooth/WLAN access coordinates of the NFC retailer device 1″, the customer device 2″ establishes a Bluetooth/WLAN connection with the retailer device 1″ and, controlled by software component 2A″, transmits to the NFC retailer device 1″ either a payment order dataset previously created in step b1) or customer identification data to create same.
b3) The NFC retailer device 1″ either uses the payment order dataset as received or itself creates a payment order dataset in software component 1A″ based on the payment data and the customer identification data.
b4) The NFC retailer device buffers the payment order dataset in a working memory of the retailer device
c′) and ultimately sends it to the server 3′ of the payment service provider.
f″) The server 3 of the payment service provider verifies approval of the payment
g′) and lastly sends a confirmation message to the NFC retailer device 1″.
h′) The NFC retailer device 1″ forwards the confirmation message to the customer device 2″ via Bluetooth or WLAN.

Furthermore, the invention can also be implemented in a plurality of modifications of the example depicted here and of the aspects of the invention emphasized further above.

1. A data transmission and processing arrangement for customer payment of a product or service at a retailer point of sale, wherein the arrangement comprises:
a retailer device equipped for near-field data communication, NFC, which comprises a working memory for storing payment data of a payment transaction and a first data exchange software component interacting with the working memory as well as the near-field data communication equipment which provides the payment data in a standardized data exchange format in the passive readout mode as well as a data interface for actively transmitting the payment data externally over the internet,
a customer device equipped for near-field data communication, NFC, which comprises a virtualized bank card with banking details stored thereon, a second data exchange software component interacting with the near-field data communication equipment which is designed to actively read out the payment data on the retailer device provided by the first data exchange software component, a processing device which interacts with the virtualized bank card and the second data exchange software component for generating a payment order dataset from the banking details and the payment data, and a working memory for storing the payment order dataset as well as a data interface for the wireless external transmitting of the payment order dataset, and
a payment service provider server of a payment service provider comprising receiving means for receiving the payment data from the retailer device and the payment order dataset from the customer device, processing means for comparative processing of both datasets, and transmitting means connected to the processing means for transmitting a confirmation message authorizing the payment to the retailer device over the internet.

2. A data transmission and processing arrangement for customer payment of a product or service at a retailer point of sale, wherein the arrangement comprises:
a retailer device equipped for near-field data communication, NFC, which comprises a working memory for storing payment data of a payment transaction and a first data exchange software component interacting with the working memory as well as the near-field data communication equipment which provides the payment data in a standardized data exchange format in the passive readout mode as well as a data interface for actively transmitting the payment data externally over the internet,
a customer device equipped for near-field data communication, NFC, which comprises a mobile app with banking details stored thereon, a second data exchange software component interacting with the near-field data communication equipment which is designed to actively read out the payment data on the retailer device provided by the first data exchange software component, a processing device which interacts with the mobile app and the second data exchange software component for generating a payment order dataset from the banking details and the payment data, and a working memory for storing the payment order dataset as well as a data interface for the wireless external transmitting of the payment order dataset,
a network provider server of an operator of a communication network, and
an online payment service provider server of an online payment service provider, wherein the network provider server comprises receiving means for receiving the payment data from the retailer device, transmitting means for forwarding the payment data to the online payment service provider server, receiving means for receiving the payment authorization confirmation message from the online payment service provider server, and transmitting means for forwarding the confirmation message to the retailer device, and
wherein the online payment service provider server comprises receiving means for receiving the payment order dataset from the customer device, receiving means for receiving the payment data from the network provider server, processing means for comparative processing of both datasets received from the retailer device and customer device, testing means to check the payment authorization, and transmitting means connected to the testing means for transmitting the payment authorization confirmation message to the network provider server and the customer device.

3. A data transmission and processing arrangement for customer payment of a product or service at a retailer point of sale, wherein the arrangement comprises:
a retailer device equipped for near-field data communication, NFC, which comprises a working memory for storing payment data of a payment transaction and a first data exchange software component interacting with the working memory as well as the near-field data communication equipment which provides the payment data in a standardized data exchange format in the passive readout mode as well as a data interface for actively transmitting the payment data externally over the internet,
a customer device equipped for near-field data communication, NFC, which comprises a mobile app with banking details stored thereon, a second data exchange software component interacting with the near-field data communication equipment which is designed to actively read out the payment data on the retailer device provided by the first data exchange software component, a processing device which interacts with the mobile app and the second data exchange software component for generating a payment order dataset from the banking details and the payment data, and a working memory for storing the payment order dataset as well as a data interface for the wireless external transmitting of the payment order dataset,
a network provider server of an operator of a communication network, and
an online payment service provider server of an online payment service provider, wherein the network provider server comprises receiving means for receiving the payment data from the retailer device, receiving means for receiving the payment order dataset from the payment service provider server, processing means for comparative processing of both datasets received from the retailer device and customer device, testing means to check the payment authorization, and transmitting means connected to the testing means for transmitting the payment authorization confirmation message to the retailer device and the online payment service provider server, and
wherein the online payment service provider server comprises receiving means for receiving the payment order dataset from the customer device, transmitting means for forwarding the payment data to the network provider server, receiving means for receiving the payment authorization confirmation message from the network provider server, and transmitting means for forwarding the confirmation message to the customer device.

4. The data transmission and processing arrangement according to claim 1, wherein the online payment service provider server assumes the inventive functions of the network provider server and thus replaces same.

5. The data transmission and processing arrangement according to claim 1, wherein the first and second data exchange software components are designed to manage the payment data in the Data Exchange Format, NDEF.

6. The data transmission and processing arrangement according to claim 1, wherein the retailer device is a point-of-sale, PoS, terminal and the customer device is a smartphone.

7. The data transmission and processing arrangement according to claim 1, wherein the retailer device comprises switching means for switching from an active NFC operating mode, in which a Request-to-Answer-To-Select (RATS) command is sent, into the passive readout mode in response to no Answer-To-Select (ATS) response after a predefined interval of time.

8. The data transmission and processing arrangement according to claim 1, wherein the virtualized bank card is virtualized on the customer device in the form of a Host Card Emulation, HCE, and protected by the white-box cryptography principle.

9. The data transmission and processing arrangement according to claim 1, wherein the payment service provider server comprises transmitting means for transmitting a payment confirmation to the retailer device as well as for transmitting an additional confirmation message to the customer device over a wireless network.

10. The data transmission and processing arrangement according to claim 1, wherein the retailer device and the customer device comprise means enabling reciprocal communication.

11. A data transmission and processing method for customer payment of a product or service at a retailer point of sale, wherein the method comprises:
providing payment data of a payment transaction in a working memory of a retailer device,
providing payment data in a standardized data exchange format in the passive readout mode of a near-field data communication, NFC, by a first data exchange software component in the retailer device which interacts with the working memory as well as the near-field data communication equipment,
providing banking details via a virtualized bank card in a customer device,
actively reading out the payment data provided on the retailer device via a second data exchange software component in the customer device interacting with the near-field data communication, NFC, equipment of the customer device,
processing the banking details and the payment data by means of a processing device interacting with the virtualized bank card and the second data exchange software component and generating a payment order dataset,
buffering the payment order dataset in a working memory of the customer device,
actively transmitting the payment data by the retailer device to a payment service provider server of a payment service provider via a data interface of the retailer device and the internet,
actively transmitting the payment order dataset wirelessly to the payment service provider server by the customer device via its data interface,
receiving the payment data from the retailer device and the payment order dataset from the customer device by the payment service provider server,
comparatively processing the payment data and the payment order dataset in the processing means of the payment service provider server, and
transmitting a confirmation message on the payment authorization to the retailer device via transmitting means of the payment service provider server and via the internet.

12. A data transmission and processing method for customer payment of a product or service at a retailer point of sale, wherein the method comprises:
providing payment data of a payment transaction in a working memory of a retailer device,
providing payment data in a standardized data exchange format in the passive readout mode of a near-field data communication, NFC, by a first data exchange software component in the retailer device which interacts with the working memory as well as the near-field data communication equipment,
providing banking details via a mobile app in a customer device,
actively reading out the payment data provided on the retailer device via a second data exchange software component in the customer device interacting with the near-field data communication, NFC, equipment of the customer device,
processing the banking details and the payment data by means of a processing device interacting with the mobile app and the second data exchange software component and generating a payment order dataset,
buffering the payment order dataset in a working memory of the customer device,
actively transmitting the payment data by the retailer device to a network provider server via a data interface of the retailer device and the internet,
forwarding the payment data from the network provider server to an online payment service provider server,
actively transmitting the payment order dataset wirelessly to the online payment service provider server by the customer device via its data interface,
receiving the payment data from the network provider server and the payment order dataset from the customer device by the online payment service provider server,
comparatively processing the payment data and the payment order dataset in the processing means of the online payment service provider server,
checking the payment authorization via testing means of the online payment service provider server,
transmitting a confirmation message on the payment authorization to the customer device and to the network provider server via transmitting means of the online payment service provider server and via the internet,
forwarding the confirmation message from the network provider server to the retailer device.

13. A data transmission and processing method for customer payment of a product or service at a retailer point of sale, wherein the method comprises:
providing payment data of a payment transaction in a working memory of a retailer device,
providing payment data in a standardized data exchange format in the passive readout mode of a near-field data communication, NFC, by a first data exchange software component in the retailer device which interacts with the working memory as well as the near-field data communication equipment,
providing banking details via a mobile app in a customer device,
actively reading out the payment data provided on the retailer device via a second data exchange software component in the customer device interacting with the near-field data communication, NFC, equipment of the customer device,
processing the banking details and the payment data by means of a processing device interacting with the mobile app and the second data exchange software component and generating a payment order dataset,
buffering the payment order dataset in a working memory of the customer device,
actively transmitting the payment data by the retailer device to a network provider server via a data interface of the retailer device and the internet,
actively transmitting the payment order dataset wirelessly to the online payment service provider server by the customer device via its data interface,
forwarding the payment order dataset from the online payment service provider server to the network provider server,
receiving the payment data from the retailer device and the payment order dataset from the online payment service provider server by the network provider server,
comparatively processing the payment data and the payment order dataset in the processing means of the network provider server,
checking the payment authorization via testing means of the network provider server,
transmitting a confirmation message on the payment authorization to the retailer device and to the online payment service provider server via transmitting means of the network provider server and via the internet,
forwarding the confirmation message from the online payment service provider server to the customer device.

14. The data transmission and processing method according to claim 11, wherein the online payment service provider server assumes the inventive functions of the network provider server and thus replaces same.

15. The data transmission and processing method according to claim 11, wherein prior to providing the payment data in the passive read-out mode, the retailer device sends out a Request-to-Answer-To-Select (RATS) command in an active NFC operating mode and switches into the passive read-out mode upon no Answer-To-Select (ATS) response after a predefined interval of time.

16. The data transmission and processing method according to claim 15, wherein the switching from the active NFC operating mode into the passive readout mode and back again is cyclically repeated a number of times until the retailer device identifies the NFC mode in which the customer device is to be addressed.

17. The data transmission and processing method according to claim 11, wherein the providing of the payment data by the retailer device and the active reading out by the customer device occurs in the Data Exchange Format, NDEF.

18. The data transmission and processing method according to claim 11, wherein the payment data is actively transmitted from the retailer device to the payment service provider server in response to the retailer device having exchanged the payment data with the customer device in one of the two NFC modes.

19. The data transmission and processing method according to claim 11, wherein the payment data comprises an identification of the retailer device, a transaction identification and a payment amount, and is in particular digitally signed by a signature component in the retailer device.

20. The data transmission and processing method according to claim 11, wherein prior to the step of actively reading out the payment data by the customer device and as a prerequisite for this step, the customer is legitimized on the customer device by the acquisition and analysis of a biometric feature or input and analysis of a PIN.

21. The data transmission and processing method according to claim 11, wherein the payment order dataset is digitally signed in the customer device, in particular by the virtualized bank card, before being transmitted to the payment service provider server.

22. The data transmission and processing method according to of claim 11, wherein the payment service provider server also transmits the payment confirmation to the customer device via transmitting means for transmitting over a wireless network.

23. A data transmission and processing method for customer payment of a product or service at a retailer point of sale, wherein the method comprises:
a) providing payment data of a payment transaction in a working memory of a retailer device in a standardized data exchange format in the passive readout mode of a near-field data communication, NFC, by a first data exchange software component in the retailer device which interacts with the working memory as well as the near-field data communication equipment,
and providing payment-related customer identification data via a mobile app in a customer device,
b) actively reading out the payment data provided on the retailer device and the access data of the retailer device for an alternative wireless connection via a second data exchange software component in the customer device interacting with the near-field data communication, NFC, equipment of the customer device,
b1) processing the payment-related customer identification data and the payment data by means of a processing device interacting with the mobile app and the second data exchange software component and generating a payment order dataset,
b2) establishing an alternative wireless connection to the retailer device than that of the NFC connection via the customer device using the access data of the retailer device and transmitting the payment order dataset from the customer device to the retailer device,
b4) buffering the payment order dataset in a working memory of the retailer device,
c′) actively transmitting the payment order dataset via the retailer device to a payment service provider server over the internet,
f″) receiving the payment order dataset via the payment service provider server and checking the payment authorization via testing means of the payment service provider server,
g′) transmitting a confirmation message on the payment authorization to the retailer device via the internet,
h′) forwarding the confirmation message from the retailer device to the customer device via the alternative wireless connection.

24. A data transmission and processing method for customer payment of a product or service at a retailer point of sale, wherein the method comprises:
a) providing payment data of a payment transaction in a working memory of a retailer device in a standardized data exchange format in the passive readout mode of a near-field data communication, NFC, by a first data exchange software component in the retailer device which interacts with the working memory as well as the near-field data communication equipment,
and providing payment-related customer identification data via a mobile app in a customer device,
b) actively reading out the payment data provided on the retailer device and the access data of the retailer device for an alternative wireless connection via a second data exchange software component in the customer device interacting with the near-field data communication, NFC, equipment of the customer device,
b1) processing the payment-related customer identification data and the payment data by means of a processing device interacting with the mobile app and the second data exchange software component,
b2) establishing an alternative wireless connection to the retailer device than that of the NFC connection via the customer device using the access data of the retailer device and transmitting the payment-related customer identification data from the customer device to the retailer device,
b3) generating a payment order dataset from the payment-related customer identification data and the payment data,
b4) buffering the payment order dataset in a working memory of the retailer device,
c′) actively transmitting the payment order dataset via the retailer device to a payment service provider server over the internet,
f″) receiving the payment order dataset via the payment service provider server and checking the payment authorization via testing means of the payment service provider server,
g′) transmitting a confirmation message on the payment authorization to the retailer device via the internet,
h′) forwarding the confirmation message from the retailer device to the customer device via the alternative wireless connection.

25. The data transmission and processing method according to claim 23, wherein the payment-related customer identification data is a bank account or an EMC card number.

26. The data transmission and processing method according to claim 23, wherein the alternative wireless connection established between the customer device and the retailer device in step b2) is a Bluetooth or a WLAN connection.
